(19) United States
(12) Patent Application Publication
(10) Pub. No.: US 2018/0022592 A1
(43) Pub. Date: Jan. 25, 2018

(54) VALVE AND A METHOD FOR CONTROLLING PRESSURE

(71) Applicant: Terence K. DEANS, Cleethorpes (GB)

(72) Inventor: Terence K. DEANS, Cleethorpes (GB)

(21) Appl. No.: 15/655,176

(22) Filed: Jul. 20, 2017

(30) Foreign Application Priority Data
Jul. 24, 2016 (GB) 1612791.2
Jun. 1, 2017 (GB) 1708781.8

(51) Int. Cl. B67C 3/12; B67C 3/28; B65B 31/04

(52) U.S. Cl. CPC B67C 3/12; B65B 31/045; B67C 3/286; B65B 3/26

(57) ABSTRACT

A valve element is provided comprising an inlet configured to receive a fluid at a first pressure, a vent that can be blocked or unblocked to vent fluid from the valve element, and a port formed in an actuating surface of the valve element at which the fluid is at a second pressure. A first internal fluid passage connects the inlet to the vent, and a second internal fluid passage connects the port to the first internal fluid passage at an angle with respect to the first fluid passage. The port is configured to be closed such that the net flow of fluid into and out of the port is substantially zero. The valve element is configured such that the second pressure is substantially equal to the first pressure when the vent is blocked and substantially lower than the first pressure when the vent is not blocked.

### CROSS REFERENCE TO RELATED APPLICATIONS

This application claims priority to United Kingdom patent applications nos. 1612791.2, filed Jul. 24, 2016, and 1708781.8, filed Jun. 1, 2017. The disclosures set forth in the referenced applications are incorporated herein by reference in their entireties.

### TECHNICAL FIELD

This invention relates generally to a valve element and a method for controlling pressure in a fluid circuit.

### BACKGROUND TO THE INVENTION

Filling machines are used in a wide range of industries to automate the dispensing of a substance, e.g. a liquid, into a container. Filling machines may be incorporated in-line with a production line and sequentially fill hundreds, or even thousands, of containers in a row. The accuracy and repeatability of the dispensed volume of the substance is of paramount importance to avoid under- or over-filling the container. This is particularly important in large scale applications, where poor filling accuracy, particularly over-filling, may result in substantial substance wastage and/or reduced profits to the manufacturer. Filling machines are typically pneumatically powered and comprise one or more pneumatic cylinders. The dispensed volume of substance (among other things) is controlled by the piston stroke length of the one or more cylinders. However, pneumatically controlled filling machines typically have poor filling accuracy and repeatability because the end points of the piston stroke are sensed using mechanical components, such as poppet valves that use a spring return. Actuators hit the valve stems at speed and the position at which an output signal is produced from the poppet valve can vary by up to 0.2 mm. This affects the timing of the filling machine, as well as the filling accuracy and repeatability. In a filling machine comprising two cylinders, four poppet valves are required which accentuates the error. A typical pneumatically controlled filling machine may have a filling error of about ±1% of the intended fill volume, such that it can fill to within 50 ml on a 5 litre fill. Such a filling accuracy is sufficient to comply with various technical standards for weights and measures in packaged goods, but both manufacturers and consumers would benefit from improved filling accuracy.

There is therefore a need for an alternative valve arrangement in a pneumatically controlled filling machine to improve the filling accuracy and repeatability.

### SUMMARY OF THE INVENTION

According to a first aspect, there is provided a valve element comprising an inlet, a vent and a port in fluid communication. The valve may further comprise an actuating surface in which the vent is formed. The valve may further have a first internal fluid passage connecting the inlet to the vent and a second internal fluid passage connecting the port to the first internal fluid passage. The second fluid passage may join and/or be oriented with respect to the first fluid passage at an angle. The vent can be blocked or unblocked to vent fluid from the valve element. The inlet may be configured to receive a fluid at a first pressure. The fluid in the port may be at a second pressure. The port may be configured, in use, to be closed such that the net flow of fluid into and out of the port is substantially zero. The valve element may be configured, in use, such that the second pressure is substantially equal to the first pressure when the vent is blocked and the second pressure is substantially lower than the first pressure when the vent is not blocked.

The valve element may be used as a position sensor to detect the end points of a movable mechanical or fluidic component such as a pneumatic cylinder. The valve element may be mounted to a stationary part, or a moving part. When the actuating surface comes into close proximity or abuts an actuator surface that will substantially block the vent, the second pressure will change. The pressure in the port may exhibit a substantial change when the actuating surface of the valve element is within 50 microns of the actuator surface. This may advantageously improve the timing accuracy of a fluid system comprising one or more movable mechanical or fluidic components, such as one or more pneumatic cylinders. Such systems include fluid filling machines where repeatability, accuracy and filling accuracy is of paramount importance to avoid over-filling or under-filling.

Advantageously, the valve element comprises no electrical components, has no internal moving parts and may further operate as a contactless position sensor. In addition, the valve element may be manufactured from chemically stable/inert and/or corrosion resistance materials. As a result, the valve element may substantially reduce the risk of producing a spark in use and may be implemented in extreme or hazardous environments, such as high temperature environments, explosive environments and corrosive environments. The valve element may be used in extremely low temperature environments, such as at high altitudes and in space (if the effects of the vacuum of space are accounted for in the design). There may also be military applications.

The angle may be substantially between 20 and 90 degrees. The angle may be substantially 45 degrees. The angle may be substantially in the range 20 degrees to 70 degrees; 30 degrees to 60 degrees; 40 degrees to 50 degrees; or 42 degrees to 48 degrees.

The second fluid passage may join the first fluid passage at or in the vicinity of the vent opening. The second fluid passage may join the first fluid passage at a location remote from the vent opening.

The actuating surface may be configured to abut a corresponding surface of an actuator. The actuating surface may be substantially flat.

The valve element may comprise a valve body, wherein the inlet, outlet, port and internal fluid passages are formed in the valve body.

The valve body may further be configured for securing to an external component. The valve body may comprise a threaded portion. Alternatively, the valve body may comprise an aperture for passing a bolt therethrough. Alternatively, the valve body may comprise a flat surface for bonding to a surface of an external component.

The fluid may be preferably a gas. The gas may be air. Alternatively, the gas may be nitrogen, or any other gas or gas mixture.

The first pressure may be substantially in any one of the ranges: 100 mbar (10 kPa) to 150 mbar (15 kPa); 150 mbar (15 kPa) to 170 mbar (17 kPa); 160 mbar (16 kPa) to 180 mbar (18 kPa); 170 mbar (17 kPa) to 190 mbar (19 kPa); 180 mbar (18 kPa) to 200 mbar (20 kPa); 190 mbar (19 kPa) to 210 mbar (21 kPa); 200 mbar (20 kPa) to 220 mbar (22 kPa); 210 mbar (21 kPa) to 230 mbar (23 kPa); 220 mbar (22 kPa) to 240 mbar (24 kPa); 230 mbar (23 kPa) to 250 mbar (25 kPa); 250 mbar (25 kPa) to 300 mbar (30 kPa), or any combination of the above.

The second pressure may be substantially in the range −10 mbar (−1 kPa) to 30 mbar (3 kPa) when the vent is not blocked. Preferably, the second pressure may be substantially in the range −10 mbar (−1 kPa) to −0.1 mbar (−0.01 kPa) when the vent is not blocked. The second pressure may be a partial vacuum.

The internal diameter of any or each of the inlet, vent, port, and first and second internal fluid passages may be substantially in the range 0.5 mm to 2 mm. The internal diameter of any or each of the inlet, vent, port, and first and second internal fluid passages may be substantially in the range 0.5 mm to 1 mm, 1 mm to 1.5 mm, 1.5 mm or 2 mm, or any combination of the above ranges.

The inlet and the port may each be located on the same side or different sides of the valve body.

The path between the inlet and the vent need not be a straight path. The first and/or second internal fluid passages may be or comprise a substantially L-shaped fluid passage. This may advantageous improve the ease of manufacture of the valve elements.

The valve element may cooperate with an actuator comprising an actuator surface to block or open the vent.

In use, the second pressure may be substantially equal to the first pressure when the actuating surface abuts or is separated from the actuator surface by a first gap, and the second pressure is substantially lower than the first pressure when the actuating surface is separated from the actuator surface by a second gap that is larger than the first gap.

The second pressure may be negative (relative to atmospheric pressure) or be a partial vacuum when the actuating surface is separated from the actuator surface by the second gap. The second pressure may be positive when the actuating surface is separated from the actuator surface by the second gap.

The second pressure when the actuating surface is separated from the actuator surface by the second gap is lower than the second pressure when the actuating surface abuts or is separated from the actuator surface by a first gap.

The angle of substantially 20 to 70 degrees may advantageously produce a negative pressure (or partial vacuum) when the actuating surface is separated from the actuator surface by the second gap. Locating the join of the first and second fluid passages at or near the vent opening may also advantageously produce a negative pressure when the actuating surface is separated from the actuator surface by the second gap.

Providing a sufficiently “low” or negative pressure when the actuating surface is separated from the actuator surface by the second gap (or the vent is substantially open) may be advantageous when using the valve element to operate a pneumatic amplifier relay or other threshold pressure-operated component.

The second pressure may be dependent on the size of the gap between the actuating surface and the actuator surface. The second pressure may be dependent on the flow of fluid through the valve element. The second pressure may be dependent on the rate of flow of fluid through the valve element.

The first gap may be substantially between 0 and 50 microns. The second gap may be substantially greater than 50 microns.

The actuator surface is substantially flat. The actuator may be separate from and not coupled to the valve element. This may advantageously allow the valve element to be used in systems where the moving parts that require end point detection have a large length of travel.

The actuator may be or comprise a piece of material (examples of which are listed below) comprising an actuator surface onto which the corresponding actuating surface of the valve element may abut.

The actuator surface may be or comprise a surface of an existing component in a fluidic or mechanical system.

The valve element and the actuator may be manufactured from the same or different materials. The valve element and/or the actuator may be or comprise a metal, plastics material, or a composite material.

Suitable materials for the valve element and/or the actuator may include, but are not limited to: stainless steel; aluminium; nylon; acetal; polyether ether ketone (PEEK); brass; bronze; titanium; or ceramic.

According to another aspect, there is provided a system comprising a valve element according to the first aspect, an actuator comprising an actuator surface, and one or more pneumatic or mechanical components. The valve element and/or the actuator may be mounted to one of said components and the actuator and/or the said one of said components may be movable.

The system may further comprise a pressure-operated switch connected to the port of the valve element. The pressure-operated switch may be controlled by a fluid at the second pressure. The pressure operated switch may have a predetermined threshold operating pressure. The pressure operated switch may be or comprise an amplifier relay. The amplifier relay may have a predetermined operating pressure. The amplifier relay may be used to control a further component such as an electrical switch.

Alternatively, the system may further comprise a pressure sensor connected to the port of the valve element. The pressure sensor may be an electronic pressure sensor. The pressure sensor may be used to measure the second pressure and provide an electrical output proportional to the second pressure. The output of the pressure sensor may be used to control a further component such as an electrical switch.

The system may comprise two or more valve elements. The two or more valve elements may be connected in parallel to a source of fluid at a first pressure. An actuator may be shared between two valve elements.

Alternatively, the system may comprise two or more valve elements connected in series with a source of fluid at a first pressure. The inlet of a given valve element may be connected to the port of another valve element.

The valve element and actuator may be or comprise part of a feedback circuit in the system.

The one or more components may be a pneumatic cylinder. The valve element may be mounted to a stationary surface of the cylinder and the actuator may be mounted to a moving surface of the cylinder, such as the piston rod.

The system may further comprise a pressure regulator connected to the inlet of the valve element. The regulator may be used to control the first pressure. The regulator may be used to set the first pressure to the predetermined operating pressure of the pressure operated switch or amplifier relay.

The system may be or comprise a pneumatic filling machine.

According to a second aspect, there is provided a method of controlling a fluid pressure in a valve element according to the first aspect, the valve element further comprising an actuator comprising an actuator surface. The inlet of the valve element may be connected to a source of fluid at a first pressure such that the valve element will vent fluid from the vent when it is not blocked. The method may comprise: moving the actuator comprising the actuator surface and/or the actuating surface between a first position where the actuator surface blocks or substantially blocks the vent, and a second position where the actuating surface and the actuator surface are separated such that the vent is not blocked; and detecting the change in the second pressure at a pressure sensitive device connected to the port.

The pressure sensitive device may be or comprise a pressure sensor. The pressure sensor may be or comprise an electronic pressure sensor. The pressure sensitive device may be or comprise a pressure-operated switch. The pressure sensitive device may be or comprise an amplifier relay.

The method may be performed using the valve element including any or all of the optional features thereof, alone or in any combination.

The method may be performed using the system, including any of the optional features thereof, in any combination.

More generally, features which are described in the context of separate aspects and embodiments of the invention may be used together and/or be interchangeable. Similarly, where features are, for brevity, described in the context of a single embodiment, these may also be provided separately or in any suitable sub-combination. Features described in connection with the device may have corresponding features definable with respect to the method and these embodiments are specifically envisaged.

### BRIEF DESCRIPTION OF DRAWINGS

In order that the invention can be well understood, embodiments will now be discussed by way of example only with reference to the accompanying drawings, in which:

FIG. 1 is a schematic diagram of a valve of a first embodiment in a closed position;

FIG. 2 is a schematic diagram of the valve of FIG. 1 in an open position;

FIG. 3 shows a cross-sectional view of a valve of a second embodiment in a closed position;

FIG. 4 shows a cross-sectional view of the valve of FIG. 3 in an open position;

FIG. 5 shows a cross-sectional view of valve of a third embodiment in an open position;

FIG. 6 shows a cross-sectional view of a valve of a fourth embodiment in an open position;

FIGS. 7 and 8 show illustrations of exemplary valve bodies of the valve of FIGS. 3 and 4;

FIG. 9 shows a schematic diagram of a fluidic circuit with a valve according to any of the embodiments of FIGS. 1 to 6;

FIG. 10 shows a schematic diagram of a fluidic circuit according to another embodiment with two valves according to any of the embodiments of FIGS. 1 to 6;

FIGS. 11 and 12 show illustrations of the fluidic circuit of FIG. 9 with a regulator, and the valve bodies of FIGS. 7 and 8, respectively, having a bleed hole;

FIGS. 13 and 14 show illustrations of the fluidic circuit of FIG. 10 with a regulator, an actuator, and the valve bodies of FIGS. 7 and 8, respectively;

FIG. 15 shows the dependence of pressure in the valve of the second embodiment on the separation between the valve body and the actuator;

FIG. 16 shows a schematic diagram of a fluid circuit for a filling machine having two valves according to the embodiments of any of FIGS. 1 to 6; and

FIG. 17 shows an illustration of the filling accuracy of a filling machine having a fluid circuit according to FIG. 16.

### DETAILED DESCRIPTION

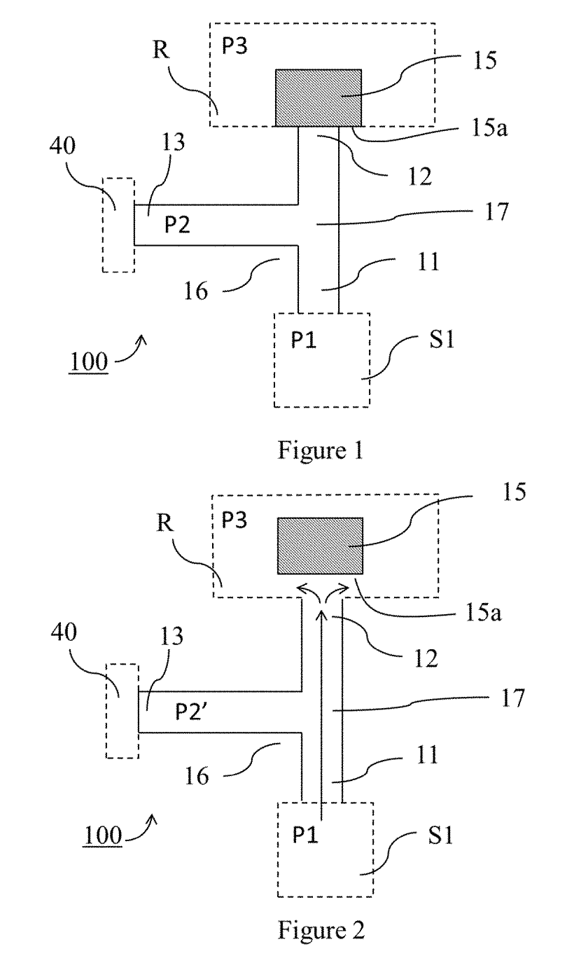

FIGS. 1 and 2 show a valve 100 (also referred to as an emitter) comprising an inlet 11, a vent 12 and a port 13. The inlet 11, the vent 12 and the port 13 are in fluid communication. The inlet 11, vent 12 and port 13 may be or comprise a valve body 16.

The inlet 11, vent 12 and port 13 fluidly connect or converge at a junction 17. The inlet 11, vent 12 and the 13 each are or comprise a respective opening. Any or each of the inlet 11, vent 12 and/or the port 13 may further be or comprise one or more fluid conduits.

The inlet 11 is configured to receive a fluid at a pressure P1. In an embodiment, the inlet 11 is configured to be connected to a fluid source S1 that supplies the fluid to the inlet 11 at the pressure P1. The inlet 11 may be configured to connect directly to the fluid source S1, or indirectly, for example, via one or more fluid circuit components (e.g. fluid conduits, piping, connectors, regulators, restrictors etc.). The fluid source S1 may be remote from the valve 100.

In an embodiment, the pressure P1 of the fluid supplied to the inlet 11 is substantially in the range 100 mbar (10 kPa) to 300 mbar (30 kPa) (measured relative to atmospheric pressure i.e. 1 bar or 100 kPa). In other embodiments the pressure is substantially in any one of the ranges: 100 mbar (10 kPa) to 150 mbar (15 kPa); 150 mbar (15 kPa) to 170 mbar (17 kPa); 160 mbar (16 kPa) to 180 mbar (18 kPa); 170 mbar (17 kPa) to 190 mbar (19 kPa); 180 mbar (18 kPa) to 190 mbar (20 kPa); 190 mbar (19 kPa) to 200 mbar (20 kPa); 200 mbar (20 kPa) to 210 mbar (21 kPa); 210 mbar (21 kPa) to 220 mbar (22 kPa); 220 mbar (22 kPa) to 230 mbar (23 kPa); 230 mbar (23 kPa) to 240 mbar (24 kPa); 240 mbar (24 kPa) to 250 mbar (25 kPa); 250 mbar (25 kPa) to 300 mbar (30 kPa), or any combination of the above.

The fluid is preferably a gas, such as air. In another embodiment, the gas may be nitrogen, or any other gas or gas mixture.

The vent 12 is configured to selectively vent (or emit) a fluid from the valve 100. This may be achieved by cooperation with an actuator 15. The valve 100 and/or the actuator 15 are configured to move between a first (closed) position wherein the vent 12 is substantially closed i.e. blocked by the actuator 15 (as shown in FIG. 1), and a second (open) position wherein the vent 12 is substantially open i.e. not blocked by the actuator 15, such that a flow of fluid can exit the valve 100 through the vent 12, as indicated by the arrows in FIG. 2.

The valve 100 and/or the actuator 15 may be moved from the open position to the closed position, and vice versa, by an external mechanism. For example, the valve 100 and/or the actuator 15 may be attached to a moving part in a fluidic system such as a cylinder piston, or a moving part in a mechanical system.

The actuator 15 comprises an actuating surface 15a configured to cover the vent 12 to completely or substantially block it when in the closed position. The actuating surface 15a may be or comprise a surface of a component in a fluidic or mechanical system. The surface 15a may be substantially equal to or greater than the size of the vent 12. Alternatively, actuator 15 may be or comprise a plunger that can enter the vent 12 to completely or substantially block it when in the closed position. In an embodiment, the valve 100 may comprise the actuator 15 (or blocker).

In the open position the vent 12 can vent fluid from the valve 100. In the example of FIG. 2, the vent 12 is configured to vent fluid to a fluid reservoir R comprising a fluid at a pressure P3, which is lower than P1. The reservoir may be atmosphere (open to air) and P3 may be atmospheric pressure, however, it will be understood that the reservoir pressure P3 may be any suitable pressure lower than P1. Ideally, this causes a flow of fluid through the valve 100.

Fluid at the port 13 will be at a pressure P2. The port 13 is configured such that, in use, the net flow of fluid into and out of the port 13 is substantially zero, regardless of whether the vent 12 is open or closed. This may be achieved by connecting a fluidic component 40 to the port 13 to close the port 13, as shown in FIGS. 1 and 2. The fluid component 40 may be or comprise a blanking cap, a sensor such as a pressure sensor/gauge, or a fluidic logic element such as a pressure-operated switch. The port 13 may be connected directly to the fluid component 40, or indirectly, for example, via one or more fluid circuit components (e.g. fluid conduits, connectors, etc.). In other words, the fluid component 40 may be remote from the valve 100.

When the vent 12 is closed, the pressure P2 of the fluid in the port 13 may be substantially the same as P1, by virtue of the fluid in the valve 100 being at equilibrium. The pressure P2 (closed) may be lower than the source pressure if there are leaks in the fluid line between the source and the valve 100.

In an embodiment, when the vent 12 is open, fluid may flow through the valve 100 from the inlet 11 and out of the vent 12. In this case, the pressure P2 (open) of the fluid at the port 13 may not be the same as the pressure P1 of the fluid at the inlet 11, by virtue of the fluid in the valve 100 not being in equilibrium. The pressure P2 (open) of the fluid in the port 13 may not be the same as the pressure P1 of the fluid at the inlet 11 when a fluid flows from the inlet 11 to the vent 12. The pressure P2 (open) of the fluid in the port 13 may be substantially lower than P1 when a fluid flows through the valve 100.

The pressure P2 of fluid in the port 13 resulting from a flow of fluid through the valve 100 (when the vent 12 is open) may be substantially lower than the pressure P2 when the vent 12 is closed, such that P2 (open)<P2 (closed).

The change in pressure of the fluid at the port 13 when the vent 12 is open and closed may be used to control or operate the fluid component 40. For example, valve 100 may be or comprise a component in a feedback loop to control a fluid system (discussed further below).

Although the inlet 11, vent 12 and port 13 are shown schematically in FIGS. 1 and 2 to connect at a T-shaped junction 17, the junction 17 may be Y-shaped, or any other arbitrarily shaped junction. The path between the inlet 11 and the vent 12 need not be a straight path.

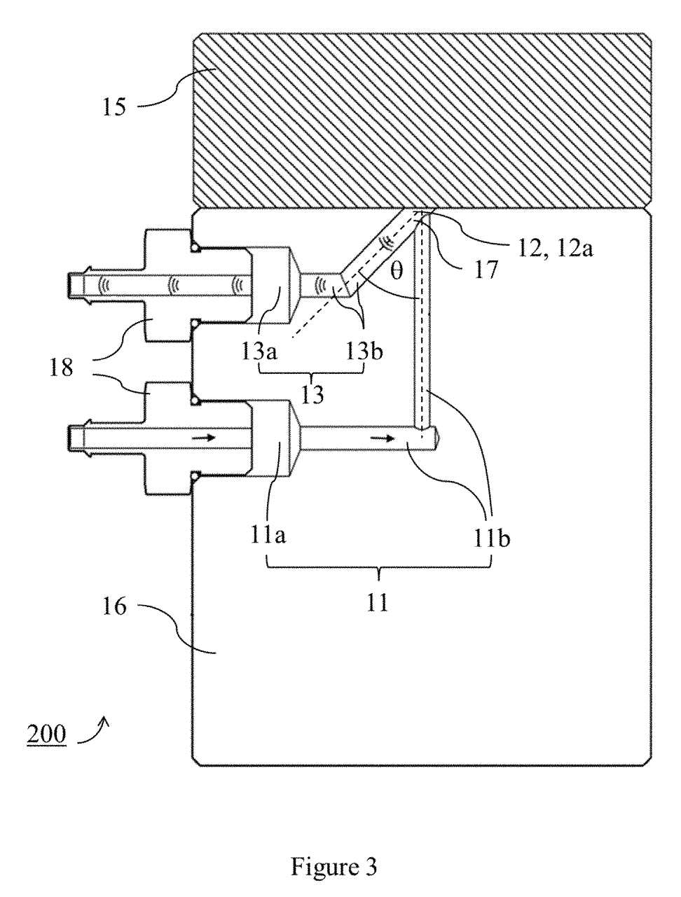

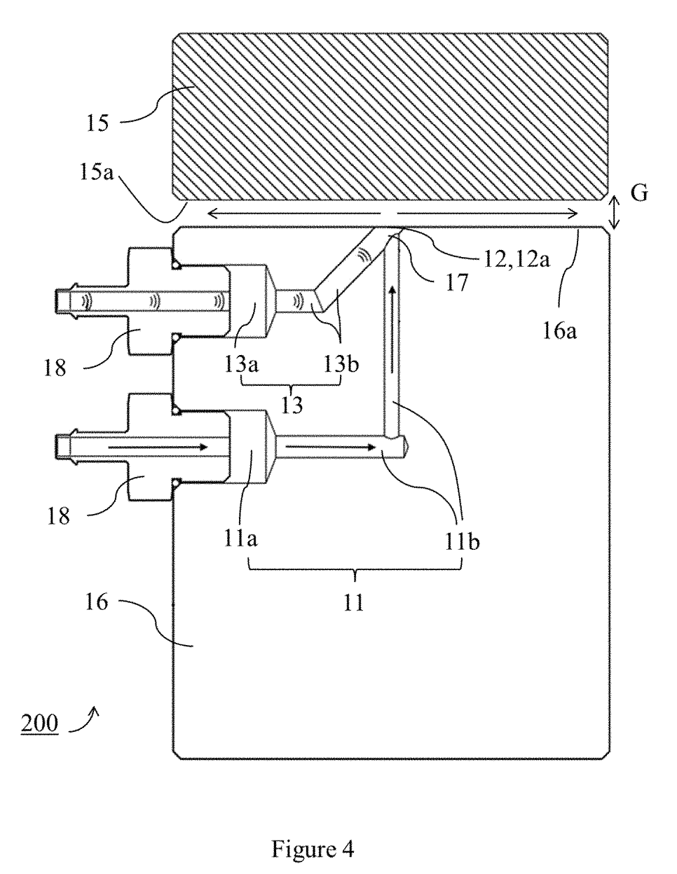

FIGS. 3 and 4 show a valve 200 according another embodiment of the invention. Valve 200 comprises a valve body 16 (or emitter). The valve body 16 comprises the inlet 11, vent 12, and the port 13, that are fluidly connected at the junction 17.

The inlet 11, the vent 12 and the port 13 are formed within the valve body 16. The inlet 11, the vent 12 and the port 13 each comprise a respective opening (11a, 12a, 13a) in an outer surface of the valve body 16. The vent opening 12a is located in an actuating surface 16a of the valve body 16 (see FIG. 4). Any or each of the inlet 11, vent 12 and/or the port 13 may further be or comprise a fluid conduit extending within the valve body 16.

In the embodiment shown in FIGS. 3 and 4, the junction 17 is located at or near the vent opening 12a. The inlet 11 comprises the inlet opening 11a and an inlet conduit 11b connecting the inlet opening 11a to the junction 17/vent opening 12a. The port 13 comprises the port opening 13a and a port conduit 13b connecting the port opening 13a to the junction 17/vent opening 12a.

The inlet conduit 11b and the port conduit 13b form an angle θ at the junction 17 of substantially 45 degrees (represented by the dashed line in FIGS. 3 and 4). In another embodiment, the angle θ may be substantially in the range 20 degrees to 70 degrees; 30 degrees to 60 degrees; 40 degrees to 50 degrees; or 42 degrees to 48 degrees. In the embodiment shown, the inlet conduit 11b is substantially “L”-shaped, but it will be appreciated that it could be straight (linear) and still be provided at an angle θ to the outlet conduit 13b (which could also be straight/linear and not “L”-shaped).

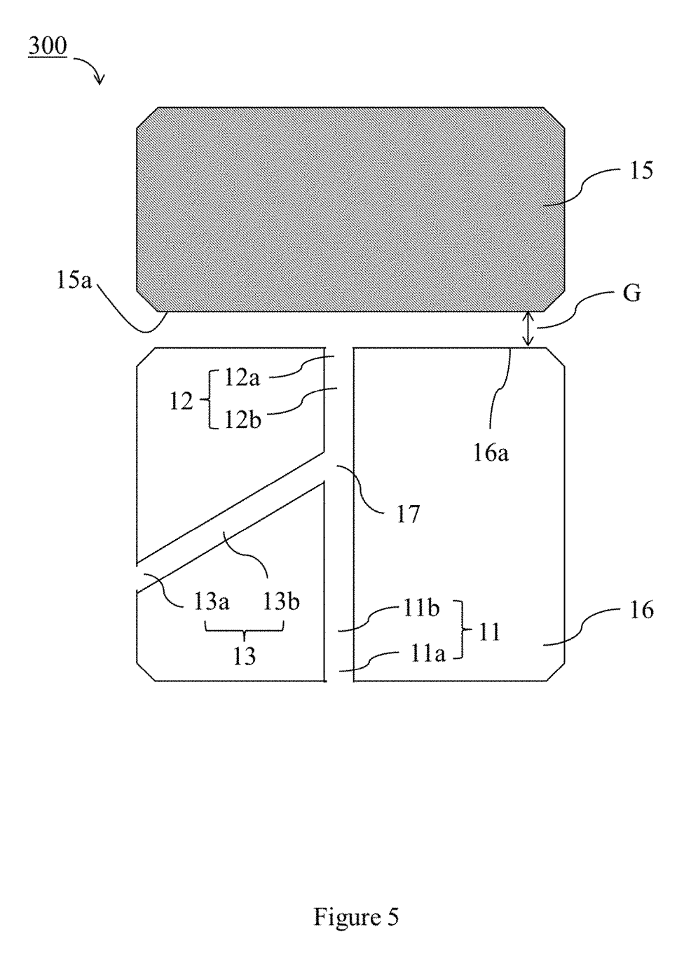

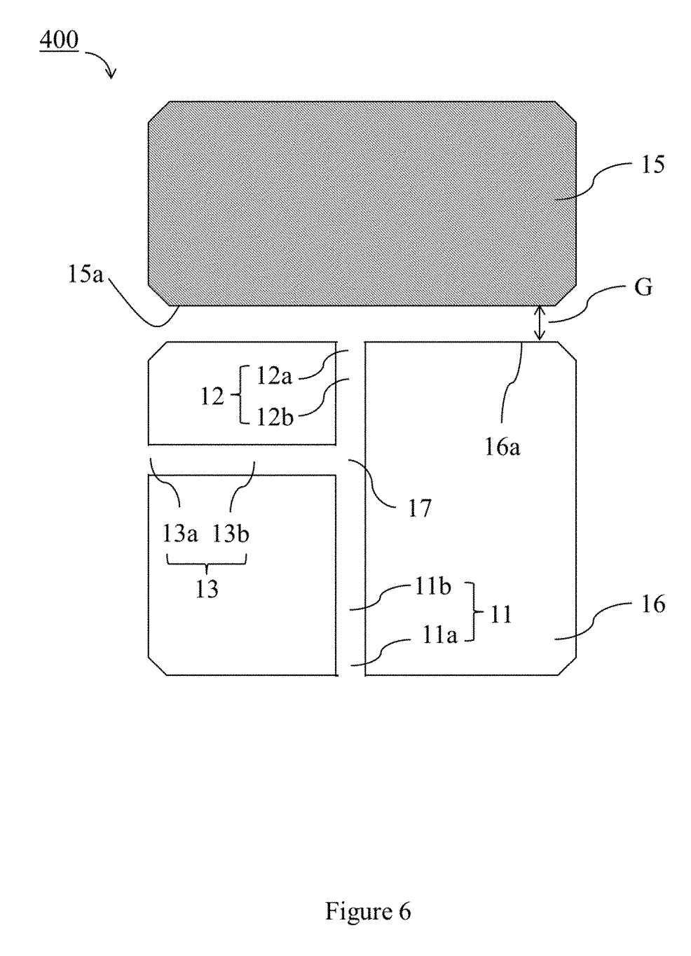

In an alternative embodiment shown in FIG. 5, the junction 17 of valve 300 may be located substantially within the valve body 16, such that vent 12 comprises a vent opening 12a and vent conduit 12b. In yet another embodiment shown in FIG. 6, the valve body 16 of valve 400 may comprise a substantially T-shaped junction 17 located within the valve body 16.

The internal diameter of any or each of the inlet 11, vent 12 and port 13 of valves 100, 200, 300, 400 may be substantially in the range 0.5 mm to 2 mm. In an embodiment, the internal diameter of any or each of the inlet 11, vent 12 and port 13 may be substantially in the range 0.5 mm to 1 mm, 1 mm to 1.5 mm, 1.5 mm or 2 mm, or any combination of the above ranges. The small diameter of the fluid passages within the valve 200 restricts the volume of fluid that passes through the valve 100, 200, 300, 400. This restricts the flow of fluid and may cause a slight drop in the pressure of the fluid on its passage through the valve 100, 200, 300, 400.

The vent 12 is configured to selectively vent (or emit) a fluid from the valve 200, via cooperation with an actuator 15. The actuator 15 comprises an actuator surface 15a. In an embodiment, the valve 200, 300, 400 may comprise the actuator 15.

The actuator 15 and/or the valve 200 are configured to move between a first (closed) position in which the vent 12 is substantially closed (FIG. 3), and a second (open) position in which the vent 12 is substantially open (FIG. 4). In the closed position (FIG. 3), the actuator surface 15a of the actuator 15 may abut the actuating surface 16a of the valve body 16. In the open position (FIG. 4), a gap G is formed between the actuator surface 15a of the actuator 15 and the actuating surface 16a of the valve body 16. In the open position, a flow of fluid can exit the valve 200 through the vent 12, as indicated by the arrows in FIG. 4.

In an embodiment the actuator 15 may be or comprise a piece of material (examples of which are listed below) comprising an actuator surface 15a onto which the corresponding actuating surface 16a of the valve body 16 may abut. Alternatively, the actuator surface 15a may be or comprise a surface of an existing component in a fluidic or mechanical system.

The actuating surfaces 15a and 16a are configured such that, when the actuating surfaces 15a and 16a abut, the gap G and the vent 12 are substantially closed. For this purpose, it will be understood that, in use, the actuating surfaces 15a and 16a must be aligned, such that the gap G is substantially uniform across the abutting area of the actuating surfaces 15a, 16a. In use, the actuating surfaces 16a and 15a may be substantially flat and parallel. Alternatively, in use, the actuating surfaces 16a and 15a may not be flat but are conformal such that any curvature or undulation in one surface is accommodated by a corresponding curvature or undulation in the other surface.

The actuator 15 and/or the valve 200 may be moved from the open position to the closed position (and vice versa) by an external mechanism. For example, the actuator 15 and/or the valve 200 may be attached to a moving part in a fluidic system (e.g. a cylinder piston rod) or a moving part in a mechanical system to impart relative movement.

The actuator 15 may be a discrete and separate element from the valve body 16. For example, the valve body 16 may be attached to a stationary surface and the actuator 15 may be attached to a moving surface, or vice versa. The moving surface may be or comprise the end of a reciprocating cylinder piston rod or a bracket attached to it, and the stationary surface may be or comprise the head of cylinder or a bracket attached to it. In this example, when the piston rod moves, depending on the direction of the piston stroke, the actuator surface 15a may move towards the stationary valve body 16, thereby closing the gap G, or the actuator surface 15a may move away from the stationary valve body 16, thereby opening the gap G.

The valve body 16 and the actuator 15 may be manufactured from the same or different materials. The valve body 16 and/or the actuator 15 may be or comprise a metal, plastics material, or a composite material.

Suitable materials for the valve body 16 and/or the actuator 15 may include, but are not limited to: stainless steel; aluminium; nylon; acetal; polyether ether ketone (PEEK); brass; bronze; titanium; or ceramic.

The inlet 11, vent 12 and port 13 of the valve 200 may be formed by removing material from the valve body 16. In an embodiment, the inlet 11, vent 12 and port 13 may be formed by drilling, milling, machining, etching, or any other suitable method. For example, the inlet 11, vent 12 and port 13 may be formed by drilling small holes into the valve body 16.

The valve 200 is manufactured to be as small as practical to reduce the amount of material used and the production cost. In an embodiment, the largest dimension of the valve 200 may be substantially in the range of 1 cm to 5 cm.

In an embodiment, when the valve 200 is manufactured from a plastics material (such as PEEK) it may be injection moulded in two parts and bonded together. Similarly, when the valve 200 is manufactured from a metal material (such as aluminium) it may be die cast in two parts and bonded together. Similarly, when the valve 200 is manufactured in stainless steel or titanium it may be or comprise two investment castings that are welded together.

In an embodiment, the valve body 16 may be incorporated into existing components by drilling suitable holes to form the inlet 11, vent 12 and port 13. In this way, the valve 200 may be retro-fitted into existing fluidic systems. Where the valve body 16 is incorporated into existing components, the valve body 16 may be substantially larger than when it is a separate component. For example, the size of the valve body 16 may be determined by the size of the existing component. Alternatively, the size of the valve body 16 may be determined by an effective interior volume of the existing component occupied by the inlet 11, vent 13 and port 13.

In other embodiments, such as valve 100, the valve body 16 may be constructed from tubing of any of the above mentioned materials.

The inlet 11 and the port 13 may be located on the same (see FIGS. 3 and 4) or different (see FIGS. 5 and 6) sides of the valve body 16. In an embodiment, the inlet 11, vent 12 and the port 13 may all be located on the same side (not shown).

The inlet 11 and the port 13 may be configured to be connected to external fluidic tubing/piping or an external fluidic component (not shown). In an embodiment, the valve 100, 200, 300, 400 may further comprise one or more coupling members 18 (see FIGS. 4 and 5) to efficiently couple the inlet 11 and/or the port 13 to a respective external fluid tubing/piping or component (not shown). The, or each, coupling member 18 may be integral with the valve body 16, or separate from the valve body 16. The, or each, coupling member 18 may comprise any suitable fluid connecting means, such as a barbed connector (as shown in FIGS. 3 and 4), a push-fit connector, or a flange. The, or each, coupling member 18 may be formed as part of the valve body 16. Alternatively, the, or each, coupling member 18 may be a separate fitting secured to the inlet 11 and/or the port 13, respectively, by any suitable mechanism. In an embodiment, the, or each, coupling member 18 may be bonded to the valve body 16, e.g. using an adhesive or by welding. In another embodiment, the, or each, coupling member 18 is configured to push into (or onto) the inlet 11 and/or the port 13, respectively, to form an interference fit. In yet another embodiment, the, or each, coupling member 18 is configured to screw into (or onto) the inlet 11 and/or the port 13, respectively. In another embodiment, the external fluidic tubing/piping may be attached to the inlet 11 and/or the outlet port 13 without the use of coupling members 18, for example using an adhesive.

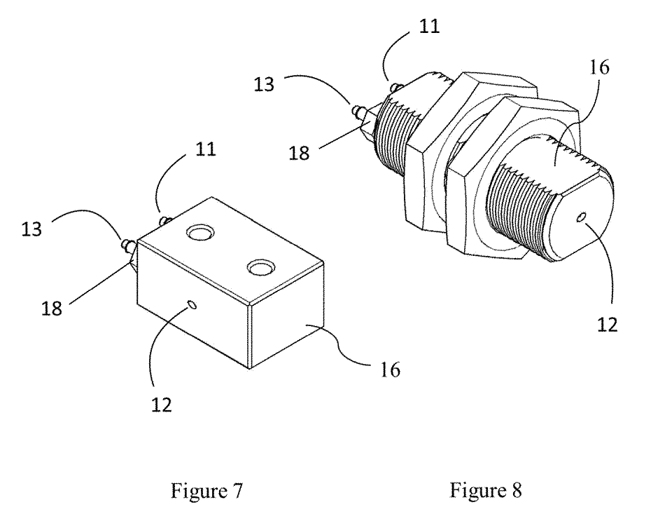

FIGS. 7 and 8 show exemplary embodiments of the valve body 16 of the valve 200. It will be understood that there may be many different variations of the style of the valve body 16 without departing from the invention as described. The valve body 16 in FIG. 7 comprises a substantially rectangular cuboid structure. This may be convenient if securing the valve body 16 to a flat surface, for example, by an adhesive. The valve body 16 in FIG. 8 is or comprises a threaded valve body 16 for coupling to a manifold or other component/surface with a corresponding threaded hole (not shown). The valve body 16 may further comprise one or more nuts to secure it to the manifold or other component.

In use, the inlet 11 of the valve 100, 200, 300, 400 is fluidly connected to a source S1 of fluid at pressure P1 and the port 13 is closed by a fluid component 40 (not shown in FIGS. 3-6 but see e.g. FIGS. 1 and 2). When the actuator 15 or valve 100, 200, 300, 400 is in the closed position such that the vent 12 is closed, no fluid flow is present and the pressure P2 of the fluid in the port 13 is substantially equal to the pressure P1 of the fluid at the inlet 11. Where P1 is a positive pressure, P2 (closed) is also a positive pressure. The pressure P (closed) may be lower than the source pressure if there are leaks in the fluid line between the source and the valve 100, 200, 300, 400.

When the vent 12 is open, the flow of fluid between the inlet 11 and vent 12 causes a pressure drop in the valve 100, 200, 300, 400 such that the pressure P2 (open) of the fluid in the port 13 is substantially lower than the pressure P1. The pressure P2 (open) of fluid in the port 13 resulting from a flow of fluid through the valve 100, 200, 300, 400 (when the vent 12 is open) is substantially lower than the pressure P2 (closed) when the vent 12 is closed, such that P2 (open)<P2 (closed).

The pressure P2 (open) may be dependent on a number of factors, including the fluid flow rate through the valve 100, 200, 300, 400, the fluid velocity through the valve 200, the pressure P1, the internal dimensions (diameter and length) of the inlet 11, vent 12 and/or connecting conduits that define the path of fluid through the valve 100, 200, 300, 400, the angle θ and, the location of junction 17 with respect to the actuating surface 16a (see below).

In an embodiment, the pressure P2 (open) may be negative pressure (relative to atmospheric pressure) or partial vacuum. In another embodiment, the pressure P2 (open) may be a positive pressure (relative to atmospheric pressure).

The size of the gap G may be as large as 30 cm, or greater, depending on the implementation of the valve 100, 200, 300, 400. For example, in the above described example of the actuator 15 being attached to the end of a cylinder piston rod, the gap G will vary as the piston rod 15 reciprocates. The valve 200 may be open for the majority of the piston stroke, and closed when the gap G is reduced to within a range of substantially 0 to 100 microns.

The size of the gap G when the actuator 15 or valve 100, 200, 300, 400 is in the closed position may be substantially in the range 0 to 100 microns, 0 to 70 microns, 0 to 50 microns, or 0 to 30 microns. A substantial change in the pressure P2 of fluid in the port 13 may only occur when the gap G is substantially less than about 100 microns.

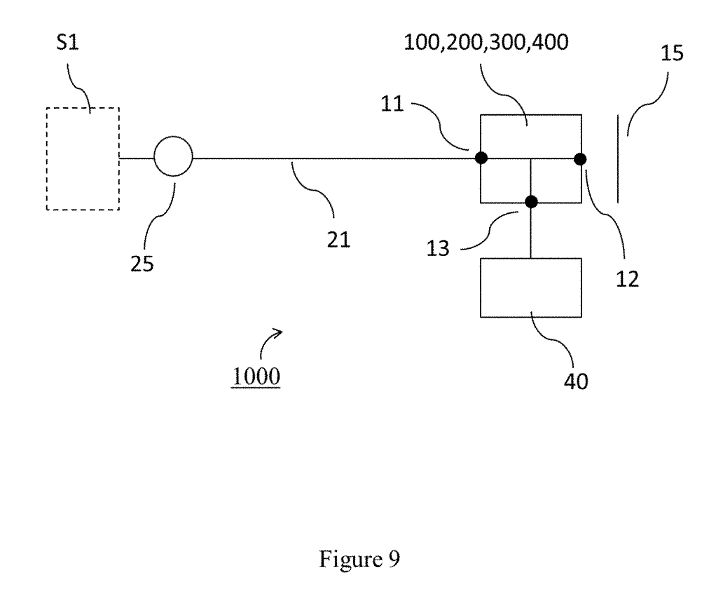

FIG. 9 shows a fluid circuit 1000 comprising a valve 100, 200, 300, 400. The inlet 11 is configured to receive a fluid at a pressure P1 from a fluid source S1. The fluid source 51 may be connected to the inlet 11 by a fluid conduit 21. The port 13 is configured to fluidly connect to a fluidic component 40. The fluidic circuit 1000 may further comprise a pressure regulator 25 positioned between the fluid source S1 and the inlet 11 to control the pressure P1 of fluid at the inlet 11 of the valve 100, 200, 300, 400. Other fluid components may be also used (e.g. conduits, piping, or connectors).

The pressure regulator 25 may be configured to adjustably control the pressure P1. For example, the fluid source 51 may be an industrial (high) pressure fluid line (with a fluid pressure typically in the range of 6-8 bars (600-800 kPa)). The pressure regulator 25 may set the pressure P1 to any of the preferred pressure ranges for operating the valve 100, 200, 300, 400 as previously described.

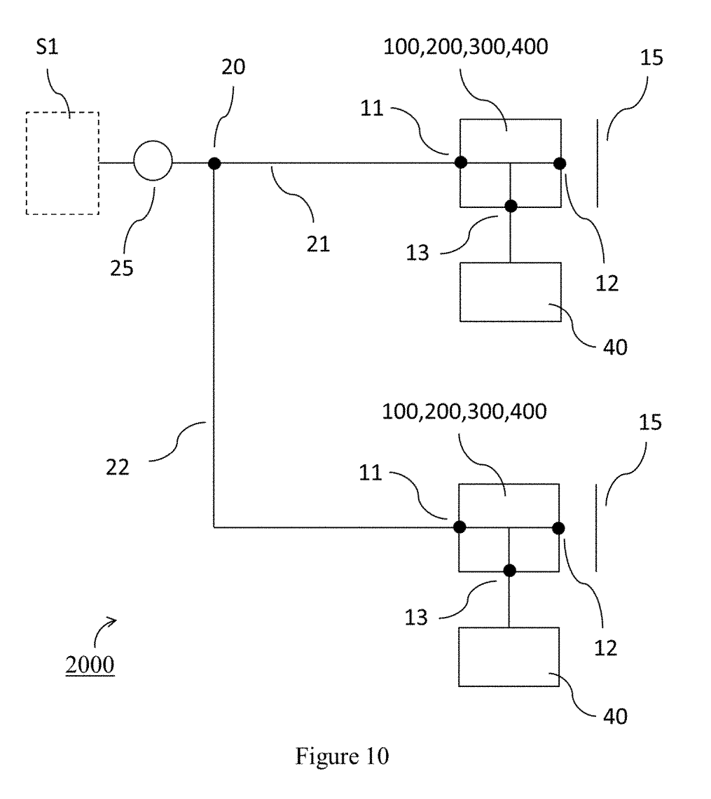

FIG. 10 shows a fluid circuit 2000 comprising two valves 100, 200, 300, 400 connected in parallel. The inlet 11 of each valve 100, 200, 300, 400 is configured to receive a fluid at a pressure P1 from a fluid source 51. The inlet 11 of each valve 100, 200, 300, 400 may be fluidly connected to the source 51 by a respective conduit 21, 22. The valves 100, 200, 300, 400 may be connected to the source 51 directly or via a fluid connector 20. The circuit 2000 may further comprise a pressure regulator 25 to control the pressure P1 at the inlet 11 of each valve 100, 200, 300, 400, as shown in FIG. 10. Alternatively, the inlet 11 of each valve 100, 200, 300, 400 may be connected to a separate regulator 25 to control the pressure P1 at the inlet 11 of each valve 100, 200, 300, 400 individually (not shown). The port 13 of each valve 100, 200,−300, 400 may be connected to a respective fluid component 40, as previously described. In an embodiment, circuit 2000 may comprise two or more valves 100, 200, 300, 400 connected to the fluid source 51 in parallel.

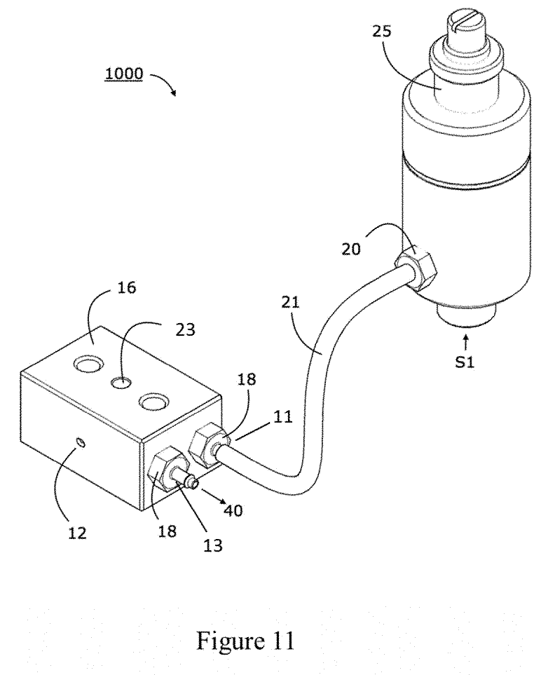

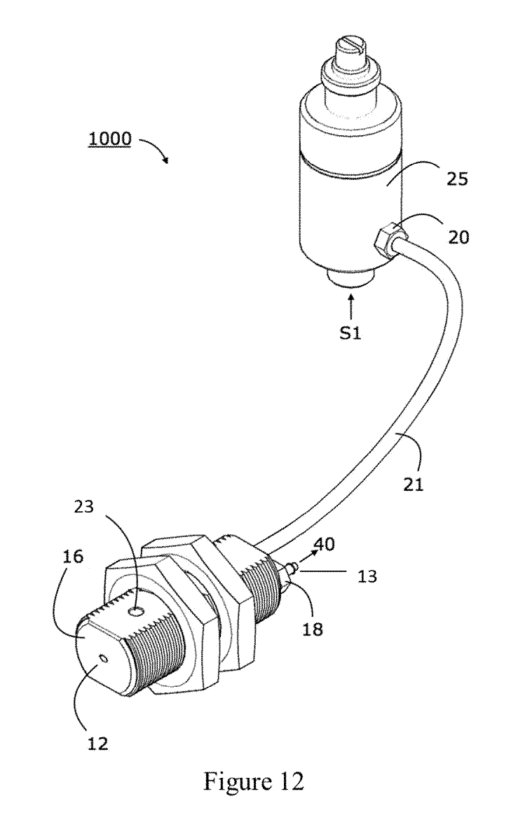

FIGS. 11 and 12 show an embodiment of fluid circuit 1000 comprising the valve body 16 of FIGS. 7 and 8 respectively. The valve body 16 further comprises a 0.5 mm diameter bleed hole 23. The fluid circuit 1000 comprises a regulator 25 and a connector 20 to introduce fluid at a pressure P1 to conduit 21. The port 13 may be connected to a component 40 (not shown) as indicated by the arrow.

When the vent 12 is blocked it produces pressure P2 (closed) at component 40 and the bleed hole 23 relieves any excess pressure that may be present in the circuit.

The port 13 may be connected by a conduit to an amplifier relay (not shown), the output of which may operate a pressure-operated electrical switch. Alternatively or additionally, the port 13 may be connected to a digital pressure sensor (not shown).

The amplifier relay 40 may selectively power an actuator or other component in the fluid system and be controlled by the pressure P2 at port 13. As such, the valve body 16 is capable of producing an electrical output or signal. The electrical switch and/or amplifier relay may be located remotely from the valve body 16.

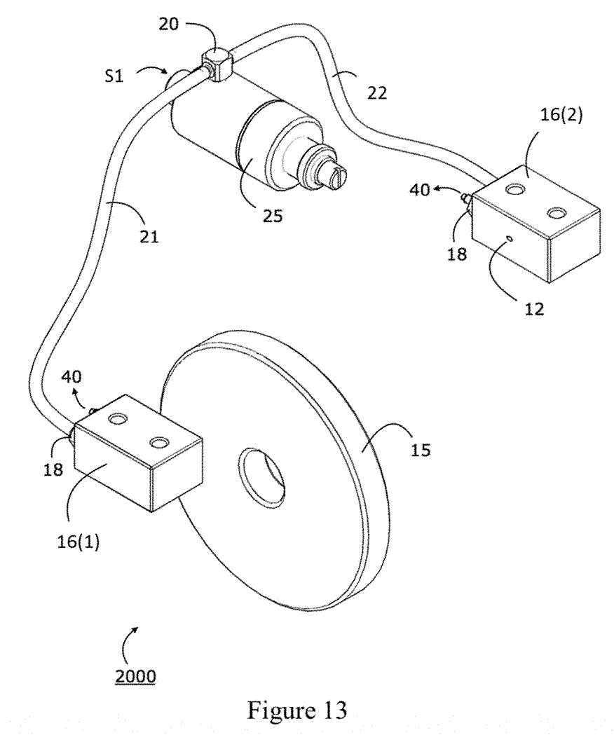

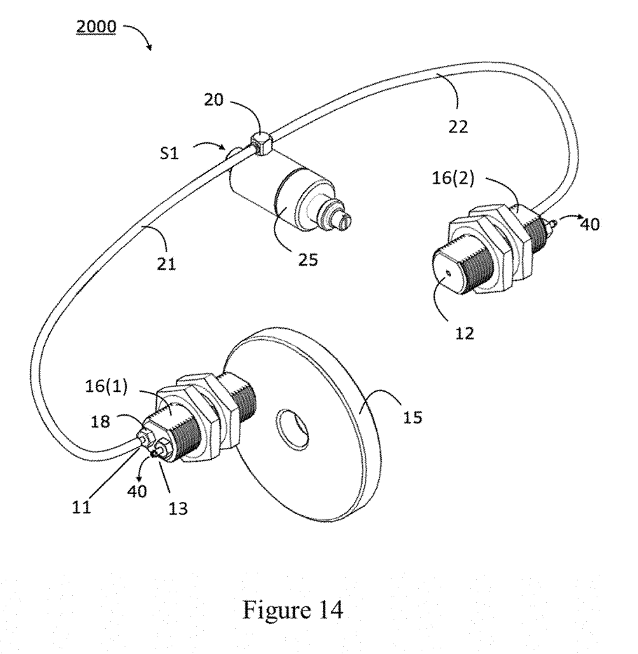

FIGS. 13 and 14 show an embodiment of fluid circuit 2000 comprising the valve body 16 of FIGS. 7 and 8, respectively. The fluid circuit 2000 comprises a regulator 25, a connector 20 to introduce fluid at a pressure P1 to conduit 21, and an actuator or blocker 15. The actuator 15 may be shared by the two valve bodies 16.

The actuator 15 may be mounted on a fluidic cylinder rod. The actuator 15 may move between a first position in which a first valve body 16(1) is substantially blocked (as shown) and a second position in which a second valve body 16(2) is substantially blocked (not shown). The port 13 of each valve body 16 may be connected to a component 40, such as an amplifier relay, as described above. In this embodiment, there is no bleed hole in the valve bodies 16. Any excess pressure may be relieved through the open valve body 16.

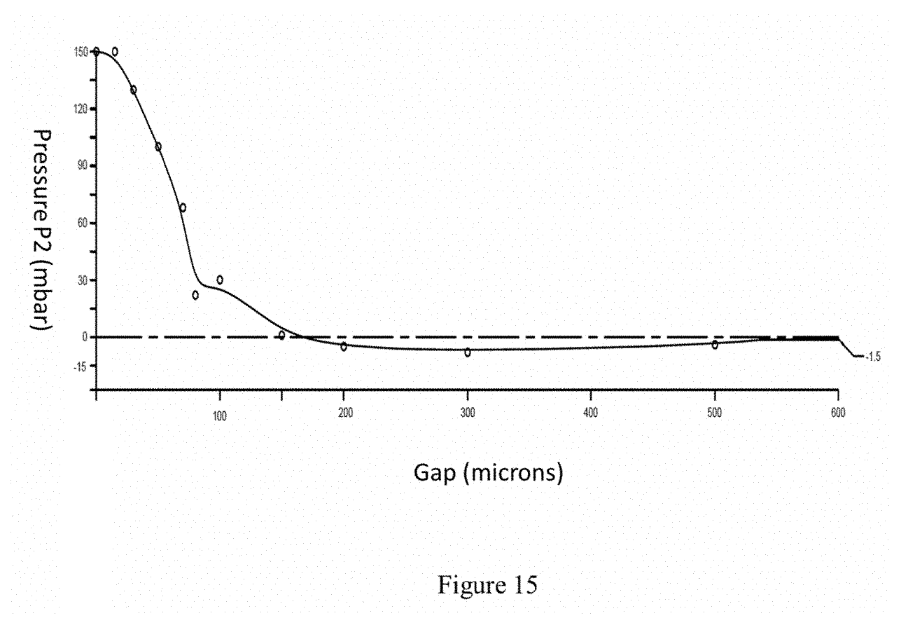

To demonstrate the operation of the valve 100, 200, 300, 400 in the circuits 1000 and 2000, FIG. 15 shows test results for the pressure P2 in the port 13 of an exemplary valve 200 as a function of the gap G between the actuating surfaces 15a, 16a. In this example, the valve 200 is connected to the source S1 as shown in circuit 1000. The fluidic component 40 is a pressure gauge connected to the port 13 via a 750 mm long 1/16 inch (1.5875 mm) internal diameter polyurethane tube. The valve 200 is constructed from acetal and comprises an angle θ of 45 degrees between the inlet conduit 11b and the port conduit 13b at the junction 17 (no bleed hole). The actuator 15 is a nylon block. Conduit 21 is a 400 mm long 1/16 inch (1.5875 mm) internal diameter polyurethane tube. The pressure P1 is set to 150 mbar using a pressure regulator 25.

As shown in FIG. 15, with a gap G of zero the vent 12 is closed and the pressure P2 (closed) is substantially the same as the pressure P1 (i.e. P2 is “high”). As the gap G increases, fluid begins to vent from the vent 12 causing the pressure P2 to drop. For gaps G greater than approximately 150 microns the pressure P2 (open) drops to a “low” valve and remains substantially constant for further increases in the gap G. Similar trends are found for valves 100, 300 and 400 (not shown).

Valve 200 exhibits a negative P2 (open) pressure (relative to atmospheric pressure), representing a partial vacuum. In other embodiments, such as valve 300 and valve 400, the pressure P2 (open) may be positive. For example, P2 (open) for valves 300 and 400 may be substantially in the range 15-25 mbar under similar conditions to those of FIG. 10 (not shown).

It has been found that an angle θ of substantially 45 degrees between the inlet conduit 11b and the port conduit 13b at the junction 17 is advantageous in producing a negative pressure P2 (open). It has further been found that locating the junction 17 at or near the vent opening 12a is also advantageous in producing a negative pressure P2 (open).

FIG. 15 demonstrates that the pressure P2 of fluid in the port 13 of the valve 200 (or valve 100, 300, 400) is dependent on the size of the gap G (or separation of the actuating surfaces 15a, 16a). In this way, the valve (or emitter) 100, 200, 300, 400 may be used as a position sensor. Further, since the size of the gap G affects the fluid flow through the valve 100, 200, 300, 400, FIG. 15 shows that the pressure P2 of fluid in the port 13 is dependent on the fluid flow rate (or fluid velocity) through the valve 100, 200, 300, 400. A sufficiently large fluid flow rate (or velocity) or gap G is required to produce a “low” pressure P2 (open) in the port 13. In other words, a threshold fluid rate (or velocity) or gap G is required to produce a “low” pressure P2 (open).

The change in pressure P2 of the fluid at the port 13 resulting from fluid venting/not venting through the valve 100, 200, 300, 400 may be used to control or operate a fluidic component 40. For example, the value 100, 200, 300, 400 may be or comprise a component in a feedback loop to control a fluid system.

The fluid component 40 may be or comprise a pressure-operated switch to control a further component in fluid system, such as a fluidic control valve or electrical switch. The pressure-operated switch may be or comprise a fluidic amplifier relay. In another example, the fluid component 40 may be or comprise a pressure sensor that measures the pressure P2 in the port 13 and provides an electrical output signal proportional to the measured pressure P2. The output signal from the pressure sensor may be used to control an electrically operated switch, or other component. Alternatively, or in addition, the pressure sensor may be used to determine the gap G size from the measured pressure P2. As shown in FIG. 10, for small gaps G substantially in the range 0 to 100 microns the pressure P2 exhibits an approximately linear dependence on the gap size G.

Providing a sufficiently “low” or negative pressure P2 (open) may be advantageous when using the valve 100, 200, 300, 400 to operate an amplifier relay or other threshold pressure-operated component, as described below.

An amplifier relay is a fluidic logic component that can be connected in-line with an industrial (high) pressure fluid line (with a fluid pressure typically in the range of 2-8 bars) and is configured to either “close” the line or “open” the line to deliver a fluid at the high pressure, depending on the pressure of a fluid in a separate “pilot” line which is typically much lower than the industrial pressure. The amplifier relay is “open” when the pilot line pressure is above a threshold pressure and is “closed” when the pilot line pressure is below a threshold pressure. Most commercially available amplifier relays require a partial vacuum to hold them closed and a pressure on the order or 75-150 mbar to hold them open. The port 13 of valve 200 may be used to provide the pilot pressure signal to an amplifier relay.

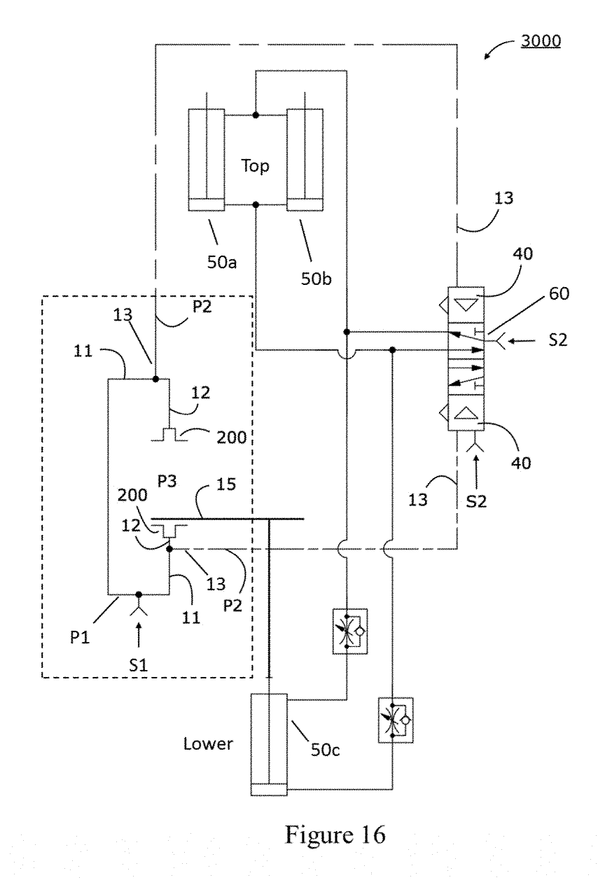

In an example, the valve 200 may be used as an end point detector in a pneumatically controlled filling machine to control the timing of the pneumatic cylinder reciprocation (see FIG. 16). The actuator 15 may be attached to a cylinder piston rod and the valve body 16 may be attached to a cylinder head, or vice versa. The port 13 of the valve 200 may be connected to the pilot line input of an amplifier relay to operate the amplifier relay. The output of the amplifier relay may be used to control further components such as a fluid control valve and/or an electrical switch.

In an example where the amplifier relay requires a minimum pressure P2 of 75 mbar to open, the port 13 of the valve 200 may only provide a sufficiently “high” pressure signal to actuate (open) the amplifier relay when the piston rod moves the actuator 15 towards to the valve body 16, such that the gap G is closed to within about 50 microns. This may signal an end point in the piston stroke and/or initiate a return stroke. For the rest of the piston stroke the gap G may be sufficiently large to provide a “low” pressure signal and hold the amplifier closed.

The valve 200 may only provide a “high” pressure P2 (closed) signal to the amplifier when the gap is less than about 50 microns (see FIG. 10). As such, the accuracy of the piston stop position and associated timing accuracy of the filling machine is high. High timing accuracy is particularly important in fluid systems comprising more than one cylinder.

The valve 200 may provide a sufficiently “high” pressure signal to an amplifier relay for non-zero gaps, such that the valve 200 can detect an end point without the actuating surfaces 15a, 16a making contact. In this way, the valve 200 may be used as a contactless position detector. This may advantageously reduce the wear and tear of the valve 200 and actuator 15 and thereby improve the reliability/repeatability of the position detection compared to conventional mechanical components such as poppet valves, where an actuator hits the valve stem at speed.

The value of P2 (closed) may be controlled by adjusting the pressure P1 at the inlet 11. This may be achieved by adjusting the pressure regulator 25 to set P1 at a desire value. Adjusting the pressure P1 at the inlet 11 may also affect the pressure P2 (open) via the change in flow rate through the valve 100, 200, 300, 400. For example, setting P1 to 80 mbar in the experiment of FIG. 10 with valve 200 gives P2 (closed) ˜80 mbar and P2 (open) ˜−1 mbar.

Alternatively, the pressure P2 (closed) may be reduced below the source pressure or the pressure set by the regulator 25 by introducing a “bleed” line between the source S1/regulator 25 and the junction 17 of the valve 200. The bleed line provides an additional vent path for the fluid. The bleed line may be or comprise an opening/hole 23 in the fluid path between the source S1/regulator 25 and the junction 17. Said opening may be or comprise an aperture such as a small drilled hole. The aperture may be or comprise a variable sized aperture, such as an adjustable vent valve (not shown). The valve body 16 may comprise the bleed hole 23 (as shown in FIGS. 11 and 12). The bleed line may further comprise a fluid conduit branching off from conduit 21 in the fluid path between the source S1/regulator 25 and the junction 17 (not shown). When vent 12 is open, fluid venting through the bleed line increases the volume of fluid that can vent through the vent 12 of the valve 100, 200, 300, 400 and increases the pressure P1 at the inlet 11 of the valve 100, 200, 300, 400. When the vent 12 is closed, the bleed line/hole 23 relieves the pressure P2 on the amplifier.

The pressure P1 required to produce a sufficiently “low” pressure P2 (open) when the vent 12 is open (to turn the amplifier off) may be greater than the pressure P2 (closed) necessary to operate the amplifier when the vent is blocked/closed. In this case, a bleed line/hole 23 may relieve the excess pressure when the vent 12 is blocked. When the vent 12 is open the bleed line/hole 23 may have little effect on P2 (or the jet velocity of fluid exiting the vent 12).

In an embodiment, two or more valves 100, 200, 300, 400 may be fluidly connected to the fluid source S1 in series. For example, the port 13 of a first valve 100, 200, 300, 400 may be connected to the inlet 11 of a second valve 100, 200, 300, 400, and the port 13 of the second valve 100, 200, 300, 400 may be connected to a component 40 (e.g. an amplifier relay). In this case, the vent 12 of each valve 100, 200, 300, 400 in the series must be blocked in order to produce a “high” pressure P2 (closed) in the port 13 of the second (final) valve 100, 200, 300, 400. For example, the valves 100, 200, 300, 400 may be used in a hatch frame having four valves 100, 200, 300, 400 in series. All of the valves 100, 200, 300, 400 need to be blocked in order to produce a “high” pressure signal, ensuring the hatch is closed properly. As the valves are not affected by temperature they may be used at high altitude.

In an embodiment where the actuator 15 is coupled to the valve body 16, the actuator 15 may be moved from the closed position to an open second position by internal means, for example, a fluid pressure within the valve 100, 200, 300, 400. In this way the valve 100, 200, 300, 400 may operate as an over-pressure detector. The actuator 15 may be biased to the closed position and configured to open when a threshold opening force is applied to the actuator surface 15a. For example, the actuator 15 may be biased to the closed position using a spring. The threshold force may be determined by the spring constant and the extension/compression of the spring when the actuator 15 is in the closed position. When the pressure P1 of the fluid in the inlet 11 exceeds a threshold pressure, the actuator 15 will open and fluid will vent from the valve 100, 200, 300, 400. The change in pressure of the fluid in the port 13 resulting from the fluid venting through the valve 100, 200, 300, 400 may be used to detect the over-pressure and/or operate a switch or other component in a feedback circuit

FIG. 16 shows a fluid circuit 3000 for a filling machine comprising two valves 200 connected in parallel, as previously described. Circuit 3000 comprises the circuit 2000 as indicated by the components within the dashed box in FIG. 16. Circuit 300 further comprises a source S2 of fluid at a high pressure (typically 6-8 bar (600-800 kPa)) and an amplifier relays 40 connected to the respective port 13 of each valve 200. The high pressure fluid is used to reciprocate/actuate three cylinders (50a, 50b, 50c) connected in parallel. Each amplifier relay is connected to a 5/2 power valve 60 to control the cylinders. S1 is a source of fluid at pressure P1 to the inlets 11 of valves 200, which is regulated to about 200 mbar (20 kPa) to operate the valves 200. Each valve 200 is used to detect an end point of the cylinder 50c piston stroke.

When the amplifier 40 receives a “high” pressure signal (P2 (closed)) from the closed (lower) valve 200 the amplifier 40 switches the 5/2 valve to open the supply to the cylinder 50c at the lower or piston end. The top section cylinders 50a, 50b fully actuate and the lower section cylinder 50c then starts to move until the actuator 15 reaches the second (upper) valve 200, at which point the sequence reverses. The top section cylinders 50a, 50b move first and then the lower section cylinder 50c follows back to the start position.

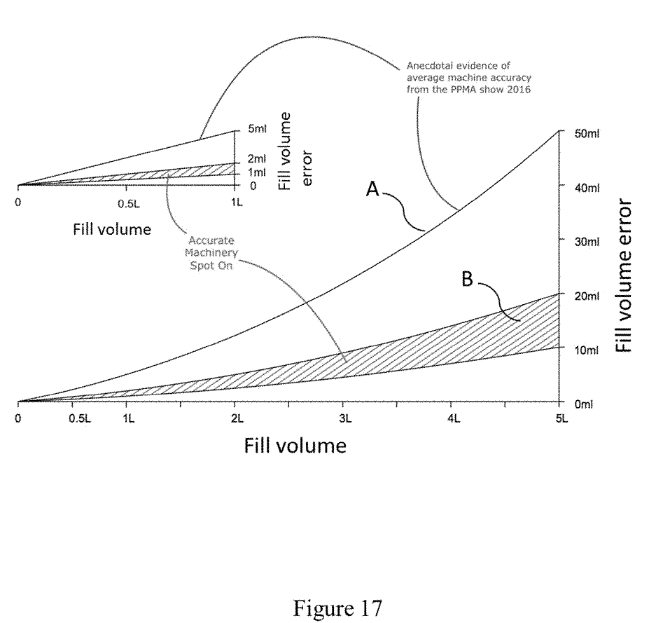

FIG. 17 shows the typical filling accuracy of a filling machine having the fluid circuit 3000 of FIG. 16. The solid line A indicates the typical filling error of a conventional filling machine using poppet valves, which is approximately 1%. The shaded region B indicates the filling error of a filling machine comprising the fluid circuit 3000. This demonstrates an improvement in filling accuracy when using the valves 200, 300, 400 described herein.

The cylinder diameter affects the volume of the fill but not the accuracy. The accuracy of a fill is a percentage of the total fill that stays the same and is related to end point detection mechanism as described. The cylinders are selected to suit the job or, when extra pressure is needed, multiple shots of a smaller cylinder can be used.

Advantageously, the valve 100, 200, 300, 400 comprises no electrical components, has no internal moving parts and may further operate as a contactless position sensor. In addition, the valve 100, 200, 300, 400 may be manufactured from chemically stable/inert and/or corrosion resistance materials. As a result, the valve 100, 200, 300, 400 substantially mitigates the risk of producing a spark and may be implemented in extreme or hazardous environments, such as high temperature environments, very low temperature environments, high altitudes, explosive environments and corrosive environments.

The valve 100, 200 and/or fluid circuit 1000, 2000 can advantageously be used to improve the timing accuracy of a fluid system with moving parts, such as one or more cylinders. Such systems include fluid filling machines where repeatability, accuracy and filling accuracy is of paramount importance to avoid over-filling or under-filling.

Advantageously, arrays of the valve 100, 200, 300, 400 may be connected in parallel or in series. In a parallel arrangement (e.g. as shown in FIG. 10) each valve 100, 200, 300, 400 may give a flow-dependent signal, i.e. “high” and “low” pressure P2 at the port 13, which may be used to control/operate a component 40. In a series arrangement (not shown), the final (downstream) valve 100, 200, 300, 400 may only give a “high” pressure P2 signal to a component 40 when all of the valves 100, 200, 300, 400 in the series are blocked. An example application for a series arrangement is a hatch or door, where an array of valves 100, 200, 300, 400 (emitters) in series could be positioned around the periphery of the hatch or hatch frame. The “high” pressure P2 signal when all the valves 200 are closed may be used as a signal in a control circuit to indicate whether or not the hatch has been properly closed. The hatch or door may be located on an aeroplane or other vehicle.

From reading the present disclosure, other variations and modifications will be apparent to the skilled person. Such variations and modifications may involve equivalent and other features which are already known in the art, and which may be used instead of, or in addition to, features already described herein.

Although the appended claims are directed to particular combinations of features, it should be understood that the scope of the disclosure of the present invention also includes any novel feature or any novel combination of features disclosed herein either explicitly or implicitly or any generalisation thereof, whether or not it relates to the same invention as presently claimed in any claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination.

For the sake of completeness it is also stated that the term “comprising” does not exclude other elements or steps, the term “a” or “an” does not exclude a plurality, and any reference signs in the claims shall not be construed as limiting the scope of the claims.

1. A valve element comprising:
an inlet configured to receive a fluid at a first pressure;
a vent that can be blocked or unblocked to vent fluid from the valve element;
a port at which the fluid is at a second pressure;
an actuating surface in which the vent is formed;
a first internal fluid passage connecting the inlet to the vent; and
a second internal fluid passage connecting the port to the first internal fluid passage, wherein the second fluid passage joins and/or is oriented with respect to the first fluid passage at an angle; and
wherein the port is configured, in use, to be closed such that the net flow of fluid into and out of the port is substantially zero, and wherein the valve element is configured, in use, such that the second pressure is substantially equal to the first pressure when the vent is blocked and the second pressure is substantially lower than the first pressure when the vent is not blocked.

2. The valve element of claim 1, wherein the angle is substantially between 20 and 90 degrees.

3. The valve element of claim 1, wherein the angle is substantially 45 degrees.

4. The valve element of any of claim 1, wherein the second fluid passage joins the first fluid passage at or in the vicinity of the vent.

5. The valve element of any of claims 1, wherein the second fluid passage joins the first fluid passage at a location remote from the vent.

6. The valve element of claim 1, wherein the actuating surface is substantially flat.

7. The valve element of claim 1, wherein the valve element is or comprises a valve body, wherein the inlet, outlet, port and internal fluid passages are formed in the valve body.

8. The valve element of claim 7, wherein the inlet and the port are each located on the same side or different sides of the valve body.

9. The valve element of claim 1, wherein the first and/or second internal fluid passages are or comprise a substantially L-shaped fluid passage.

10. The valve element of claim 1, further comprising an actuator comprising an actuator surface.

11. The valve element of claim 10, wherein, in use, the second pressure is substantially equal to the first pressure when the actuating surface abuts or is separated from the actuator surface by a first gap, and the second pressure is substantially lower than the first pressure when the actuating surface is separated from the actuator surface by a second gap that is larger than the first gap.

12. The valve element of claim 11, wherein the second pressure is negative or a partial vacuum when the actuating surface is separated from the actuator surface by the second gap.

13. The valve element of claim 11, wherein the first gap is substantially between 0 and 50 microns, and wherein the second gap is substantially greater than 50 microns.

14. The valve element of claim 10, wherein the actuator surface is substantially flat.

15. The valve element of claim 10, wherein the actuator is separate from and not coupled to the valve element.

16. A method of controlling a fluid pressure in a valve element, the valve element comprising:
an inlet configured to receive a fluid at a first pressure;
a vent that can be blocked or unblocked to vent fluid from the valve element;
a port at which the fluid is at a second pressure;
an actuating surface in which the vent is formed;
a first internal fluid passage connecting the inlet to the vent; and
a second internal fluid passage connecting the port to the first internal fluid passage, wherein the second fluid passage joins and/or is oriented with respect to the first fluid passage at an angle;
wherein the port is configured, in use, to be closed such that the net flow of fluid into and out of the port is substantially zero, and wherein the valve element is configured, in use, such that the second pressure is substantially equal to the first pressure when the vent is blocked and the second pressure is substantially lower than the first pressure when the vent is not blocked; and
an actuator comprising an actuator surface;
wherein the inlet is connected to a source of fluid at a first pressure, the method comprising:
moving the actuator comprising the actuator surface and/or the actuating surface between a first position where the actuator surface substantially blocks the vent, and a second position where the actuating surface and the actuator surface of the actuator are separated such that the vent is not blocked; and
detecting the change in the second pressure at a pressure sensitive device connected to the port.

17. The method of claim 16, wherein the pressure sensitive device is a pressure sensor.

18. The method of claim 16, wherein the pressure sensitive device is a pressure-operated switch.

19. The method of claim 16, further comprising controlling the movement of the actuator and/or actuating surface based on the detected change in the second pressure.

20. A valve element comprising:
an inlet configured to receive a fluid at a first pressure;
a vent that can be blocked or unblocked to vent fluid from the valve element;
an internal fluid passage connecting the inlet to the vent;
a port at which the fluid is at a second pressure, the port joining the internal fluid passage between the inlet and vent at an angle with respect to the internal fluid passage at the joint; and
an actuating surface in which the vent is formed;
wherein, in use, when the actuating surface comes into close proximity with an actuator surface of an actuator that will substantially block the vent, the second pressure will change.
